(19) United States
(12) Patent Application Publication
(10) Pub. No.: US 2003/0175191 A1
(43) Pub. Date: Sep. 18, 2003

(54) Method for catalytic reduction of nitrogen oxide emissions

(76) Inventors: Catherine Hedouin, Geouvieux (FR); Thierry Seguelong, Lagord (FR)

Correspondence Address: BURNS DOANE SWECKER & MATHIS L L P, POST OFFICE BOX 1404, ALEXANDRIA, VA, 22313-1404, US

(21) Appl. No.: 10/203,205

(22) PCT Filed: Feb. 5, 2001
(86) PCT No.: PCT/FR01/00338

(30) Foreign Application Priority Data
Feb. 7, 2000 (FR) 00/01487

(51) Int. Cl. B01D 53/56

(52) U.S. Cl. 423/239.1; 502/324

(57) ABSTRACT

The present invention concerns a process for trapping NOₓ, in the treatment of with a view to reducing emissions of oxides of nitrogen.

The process of the invention is characterized in that a massive catalyst is used based on an oxide with formula (1):

AₓMn_{1-y}B_{y}O_{2±δ}

in which A represents one or more elements selected from groups IA, IIA, IIIA of the periodic table; B is a metal selected from tin and elements from groups IVA to IIIB of the periodic table; x and y have the following values: 0.16≦x≦1 and 0≦y≦0.5, the oxide having a lamellar or tunnel structure.

The present invention relates to a process for trapping NOₓ, in the treatment of gas with a view to reducing emissions of oxides of nitrogen.

Emissions of oxides of nitrogen (NOₓ), particularly from exhaust gases from automotive engines, can be reduced using “three way” catalysts which use the reducing gases present in the mixture in stoichiometric proportions. Any excess oxygen results in a substantial deterioration in catalyst performance.

Some engines, however, such as diesel engines or lean burn gasoline engines, economise on fuel but emit exhaust gases which permanently contain a large excess of oxygen, for example at least 5%. A standard three way catalyst is thus useless with NOₓ emissions in such a case. Further, limiting NOₓ emissions has been rendered imperative by the tightening of automobile post combustion regulations which now extend to such engines.

To overcome the problem, systems known as NOₓ traps have been proposed which can oxidise NO to NO₂ then adsorb the NO₂ formed. Under certain conditions, the NO₂ is leached out then reduced to N₂ by reducing species contained in the exhaust gases. Such NOₓ traps have a number of disadvantages, however. Their optimum functional range is located in a relatively low temperature range, generally between 200° C. and 300° C., and they are of little or no effectiveness at higher temperatures. Thus, it would be advantageous to have available a system that can function at higher temperatures than those of current systems. Further, known NOₓ traps are generally based on precious metals. Such metals are expensive and their availability can be a problem. It would also be advantageous to have available catalysts that were free of precious metals or with a small amount of such metals to reduce the costs.

Thus, the aim of the invention is to provide an catalyst that is effective as a NOₓ trap at high temperatures and that can function without precious metals or with a small amount of such metals.

To this end, the process of the invention for trapping NOₓ in the treatment of a gas with a view to reducing emissions of oxides of nitrogen is characterized in that a massive catalyst is used based on an oxide with formula (1):

AₓMn_{1-y}B_{y}O_{2±δ}

in which:

A represents one or more elements selected from groups IA, IIA, IIIA of the periodic table;

B is a metal selected from tin and elements from groups IVA to IIIB of the periodic table;

x and y have the following values:

0.16≦x≦and 0≦y≦0.5,

the oxide having a lamellar or tunnel crystallographic structure.

Further characteristics, details and advantages of the invention will become more apparent from the following description and non limiting examples given by way of illustration.

The periodic table referred to in the present description is that published in the Supplément au Bulletin de la Société Chimique de France n° 1 (January 1966).

The catalyst used in the present invention is a massive catalyst. This means a catalyst in which the oxide with formula (1) is present through the entire volume of the catalyst in a homogeneous manner and does not follow a distribution or concentration gradient, for example on the surface of the volume of the catalyst. In other words, the catalyst used in the invention is a non supported catalyst, the active phase; in this instance the oxide with formula (1), is not deposited on a porous cerium oxide, zirconium oxide or silica type support, for example.

Regarding the constituent elements of the oxide with formula (1), A can represent one or more elements selected from said groups of the periodic table.

Firstly, A can be selected from lithium, sodium, potassium, rubidium and caesium. More particularly, A can be potassium or sodium or a combination of said two elements in respective proportions that can be varied.

A can also be selected from magnesium, calcium, strontium or barium.

A can also be an element selected from scandium, yttrium and the rare earths. The term “rare earth” means elements from the group constituted by elements from the periodic table with an atomic number in the range 57 to 71 inclusive.

As indicated above, the proportion of element A in the oxide is given by the value of x, x possibly being in the range 0.16 to 1, limits included. More particularly, x can satisfy the relationship 0.25≦x≦0.7.

In the oxide with formula (I), the manganese can be substituted by an element B.

Element B can be selected from transition metals, i.e., from elements from groups IVA, VA, VIA, VIIA, VIII, IB and IIB.

Titanium can be mentioned as an element from group IVA.

More particular elements from group VIII that can be cited are iron, platinum, palladium and rhodium.

More particularly, silver can be selected as the element from group IB.

Zinc can be mentioned as the element from group IIB.

Finally, element B can be tin in oxidation state IV.

The proportion of element B in the oxide is given by the value of y mentioned above. More particularly, y can satisfy the relationship 0.001≦y≦0.01.

It should be noted that the value of δ will depend on the nature of elements A and B and the oxidation state of the manganese, which can vary between +3 and +7.

The oxide with formula (1) can also have a specific crystallographic structure. This structure is either a lamellar or a tunnel type. The lamellar structure corresponds to a structure in which elements Mn and O together form a first layer separated from a second layer of these same elements by a third layer of elements A, with this sequence of layers being repeated. In the tunnel structure, the layers formed by the ensemble of elements Mn and O form a tunnel inside which elements A are located.

The following structure types can be cited: vemadite, hollandite, romanechite or psilomelane, bimessite, todorokite, buserite, lithiophorite, RUB-7, Rb_{0.27}MnO₂, Na_{0.44}MnO₂, Li_{0.44}MnO₂, Ba₆Mn₂₄O₄₈,α-NaMnO₂, α-LiMnO₂, β-NaMnO₂, β-LiMnO₂.

Finally, it should be noted that the oxide with formula (1) can optionally be hydrated by intercalation of H₂O molecules and/or protons H⁺ between the lamellae or in the tunnels.

In a variation of the invention, the catalyst used essentially consists of the oxide with formula (I). The term “essentially consists” means that the catalyst of the invention has the catalytic activity described in the absence of any element other than those mentioned above as forming part of the composition of the oxide with formula (1) or that the oxide can be present in the catalyst in combination with other elements that are catalytically inactive.

Oxides with formula (1) can be prepared by different types of processes, in particular by precipitating salts of constituent elements (wet method), by sol-gel methods, by ion exchange reactions on elements A or by solid-solid reaction. It is possible to start from oxides of elements A and MnO₂, which are ground and mixed together then calcined at a temperature that is sufficient to obtain the desired oxide, for example between 450° C. and 1000° C. Calcining can be carried out in air, in argon or in oxygen.

When preparing an oxide also comprising an element B, it can be introduced on synthesis, for example in the form of an oxide of element B if solid-solid reaction is carried out or in the form of a salt of this element B if a wet method is used. It is also possible to prepare the oxide with formula (1) first without element B then to incorporate that element in a second stage by impregnation.

The catalyst of the invention can be used in the form of a powder, but it can optionally be formed into granules, beads, cylinders, foams or extrudates, for example as honeycombs, with varying dimensions.

The catalyst can also be deposited in the form of a coating (washcoat) onto a substrate that is, for example, a metallic monolith or a ceramic or a ceramic foam, the substrate being catalytically inactive.

Examples of gases that can be treated by the present invention are those from gas turbines, from power station turbines or from internal combustion engines. In the latter case, they may in particular be diesel engines or lean burn engines.

The catalyst of the invention functions as a NOₓ trap when brought into contact with gas with a high oxygen content. The term “gas with a high oxygen content” means gases with an excess of oxygen with respect to the quantity necessary for stoichiometric combustion of the fuel and, more precisely, gas with an excess of oxygen with respect to the stoichiometric value λ=1, i.e., gases for which the value of λ is greater than 1. The value λ is correlated with the air/fuel ratio in a manner that is known per se, in particular in the internal combustion engine field. Such gases can be those from a lean burn engine with an oxygen content (expressed by volume) of at least 2%, for example, and those with a still higher oxygen content, for example gas from diesel type engines, i.e., at least 5% or more than 5%, more particularly at least 10%, this content possibly being between 5% and 20%.

The invention also concerns a system for treating a gas with a view to reducing emissions of oxides of nitrogen, which can be of the type mentioned above, more particularly those with an excess of oxygen with respect to the stoichiometric value. This system comprises a catalyst of the type described above.

An example will now be given.

### EXAMPLE

The example concerns a catalyst with formula K_{0.47}MnO₂.

The catalyst was prepared as follows:

We started with KOH and MnO₂ with a 5% by weight excess of KOH with respect to stoichiometry. The products were weighed, ground then dry mixed. The mixture was then calcined for 15 hours at 700° C. in air (rate of temperature rise 2° C./min). A product was obtained with a lamellar crystallographic structure with a P3 or P′3 type lattice and R3m space group.

The NOₓ trap evaluation test was carried out as follows on a product that had been stored in ambient air.

0.15 g of powdered NOₓ trap was loaded into a quartz reactor. The powder used had been compacted then ground and sieved in advance to isolate grains in the size range 0.125 to 0.250 mm.

The reaction mixture at the inlet to the reactor had the following composition (by volume):

NO:300 vpm

O₂:10%

CO₂:10%

H₂O:10%

N₂:qsp 100%

The overall flow rate was 30 Nl/h.

The HSV was of the order of 150000 h⁻¹.

The NO and NOₓ signals (NOₓ=NO+NO₂) were recorded continuously along with the temperature in the reactor.

The NO and NOₓ signals were recorded using a Nicolet Magna IR 560 ESP with Fourrier Transform analyser.

The NOₓ traps were evaluated by determining the total quantity of adsorbed NOₓ (expressed as mg NO/g of trapped or active phase) until saturation of the trap phase. The experiment was repeated at different temperatures between 300° C. and 450° C. It was then possible to determine the optimum temperature zone for the function of the NOₓ traps.

The results for NOₓ trapping of the product in the examples are given in the table below; the values shown in the table correspond to the quantity of stored NOₓ, expressed in mg of NO/g of catalyst.

| Temperature, ° C. | Quantity of NOₓ |
|---|---|
| 300 | 3.8 |
| 350 | 14.3 |
| 400 | 21.3 |
| 450 | 19.8 |

It can be seen that the maximum NOₓ storage is at high temperatures in the range 350° C. to 450° C.

1. A process for trapping NOₓ in the treatment of a gas with a view to reducing emissions of oxides of nitrogen, characterized in that a massive catalyst is used based on an oxide with formula (1):
AₓMn_{1-y}B_{y}O_{2±δ}
in which:
A represents one or more elements selected from groups IA, IIA, IIIA of the periodic table;
B is a metal selected from tin and elements from groups IVA to IIIB of the periodic table;
x and y have the following values:
0.16≦x≦1 and 0≦y≦0.5;
the oxide having a lamellar or tunnel crystallographic structure.

2. A process according to claim 1, characterized in that a catalyst with formula (1) is used in which 0.25≦x≦0.7.

3. A process according to claim 1 or claim 2, characterized in that a catalyst with formula (1) is used in which A is potassium and/or sodium.

4. A process according to one of the preceding claims, characterized in that a catalyst with formula (1) is used in which B is platinum, palladium or rhodium.

5. A process according to one of the preceding claims, characterized in that a catalyst is used with a structure of the vernadite, hollandite, romanechite or psilomelane, bimessite, todorokite, buserite, lithiophorite, RUB-7, Rb_{0.27}MnO₂, Na_{0.44}MnO₂, Li_{0.44}MnO₂, Ba₆Mn₂₄O₄₈, α-NaMnO₂, α-LiMnO₂, β-NaMnO₂ or β-LiMnO₂ type.

6. A process according to one of the preceding claims, characterized in that internal combustion engine exhaust gas is treated.

7. A process according to claim 6, characterized in that a gas is treated the oxygen content of which is at least 2% by volume, more particularly at least 5%.

8. A catalytic system for treating internal combustion engine exhaust gas, for carrying out the process according to one of claims 1 to 6.
